(19) United States
(12) Patent Application Publication
(10) Pub. No.: US 2025/0278193 A1
(43) Pub. Date: Sep. 4, 2025

(54) MANAGING I/O OPERATIONS ASSOCIATED WITH A COMPUTE EXPRESS LINK (CXL) MEMORY DEVICE

(71) Applicant: Micron Technology, Inc., Boise, ID (US)

(72) Inventor: John M. Groves, Austin, TX (US)

(21) Appl. No.: 19/045,769

(22) Filed: Feb. 5, 2025

Related U.S. Application Data
(60) Provisional application No. 63/560,283, filed on Mar. 1, 2024.

(51) Int. Cl. G06F 3/06

(52) U.S. Cl. CPC G06F 3/0611; G06F 3/0631; G06F 3/0673

(57) ABSTRACT

A system can include a plurality of dynamic capacity devices and a processing device to perform operations including receiving, from a host system, a request to perform an input/output (I/O) operation at a first memory region of a first dynamic capacity device. The operations include determining, based on a data structure referencing a namespace accessible to the host system and to the plurality of dynamic capacity devices, that the host system is associated with an access privilege to access the first memory region of the first dynamic capacity device. The operations include identifying, based on the data structure, a range of physical addresses of the first dynamic capacity device, wherein the range is associated with the first memory region. The operations include causing the I/O operation to be performed on a plurality of memory cells addressable by the range of physical addresses at the first dynamic capacity device.

### REFERENCE TO RELATED APPLICATION

This application claims the priority benefit of U.S. Provisional Patent Application No. 63/560,283, filed Mar. 1, 2024, the entirety of which is incorporated herein by reference.

### TECHNICAL FIELD

Embodiments of the disclosure relate generally to memory sub-systems, and more specifically, relate to managing the performance of input/output (I/O) operations associated with a compute express link (CXL) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure;

FIG. 2 is a block diagram of an example system for managing the performance of input/output (I/O) operations associated with a compute express link (CXL) memory device, in accordance with some embodiments of the present disclosure.

FIG. 3 illustrates an example data structure referencing a namespace accessible to a host system and a plurality of dynamic capacity devices, in accordance with some embodiments of the present disclosure.

FIG. 4 is a flow diagram of an example method for managing the performance of VO operations associated with a compute express link (CXL) memory device, in accordance with some embodiments of the present disclosure.

FIG. 5 is a block diagram of an example computer system in which embodiments of the present disclosure may operate.

### DETAILED DESCRIPTION

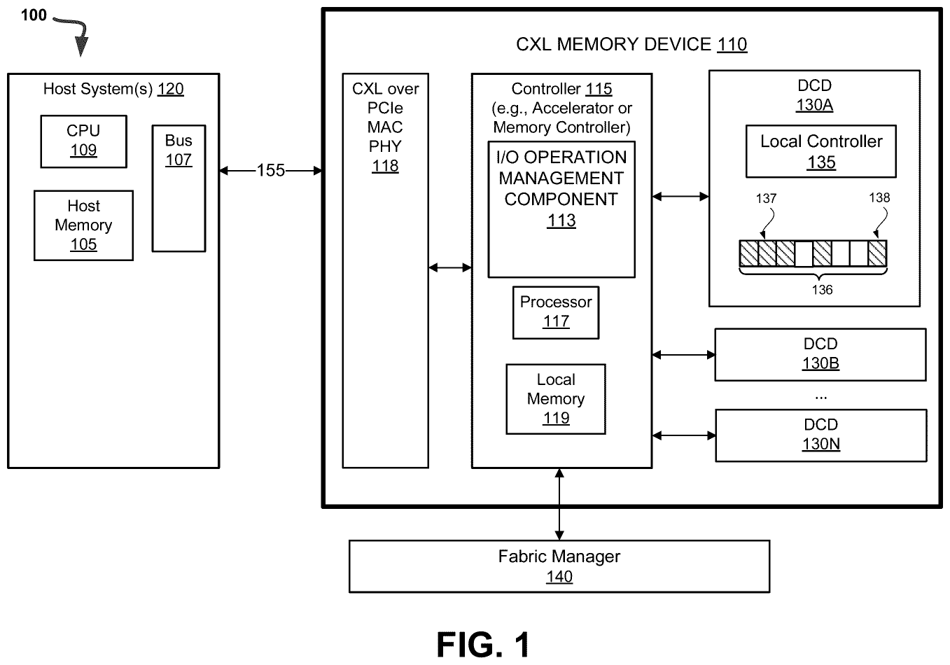

Aspects of the present disclosure are directed to managing the performance of input/output (I/O) operations associated with a compute express link (CXL) memory device. A memory sub-system can be a storage device, a memory module, or a combination of a storage device and a memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A CXL system maintains memory coherency between a central processing unit (CPU) memory space and memory on memory-attached devices, which allows for resource sharing for higher performance, reduced software stack complexity, and a lower overall system cost. Generally, CXL is an interface standard that can support a number of protocols that can run on top of a Peripheral Component Interconnect Express (PCIe), including a CXL.io protocol, a CXL.mem protocol, and a CXL.cache protocol. PCle is an interface standard used for connecting various hardware components, primarily in high-performance computing systems. The CXL.io protocol is a PCle-like protocol that can be viewed as an “enhanced” PCIe protocol that is capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., Non-Volatile Memory Express (NVMe) traffic) can run through the CXL.io protocol. The CXL.mem and CXL.cache protocols can share a common link layer and transaction layer. Accordingly, the CXL protocols can be multiplexed and transported via a PCle physical layer.

A memory device that is attached to a host (e.g., a host device, etc.) via CXL can be referred to as a CXL memory device, which can provide additional device bandwidth and capacity to host processors. The CXL memory device is independent of the host device. In some implementations, the CXL memory device can partition memory resources into multiple logical devices (also referred to herein as “dynamic capacity devices”), and each logical device can be visible as a memory device. In some implementations, the CXL memory device can serve multiple host systems. In some implementations, certain aspects of the CXL memory device can be managed by a separate entity (e.g., an external logical process) referred to as a fabric manager (also referred to herein as a “fabric management component”). In some examples, the fabric manager can be a distributed application running on bare metal controllers and/or switches. The fabric manager can configure resource allocation for multiple host systems across the logical devices.

For some memory devices, high-performance computing (HPC) applications, such as large-scale numerical simulations, data analysis, and machine learning, can involve the use of large amounts of memory bandwidth and capacity to perform their computations. Some memory device architectures, such as DDR and GDDR, can be unable to fully meet these demands, resulting in limitations in performance and scalability. In particular, moving data back and forth between storage and processing units can often lead to bottleneck and latency issues, which can be a prevalent issue in data-intensive or memory-intensive applications, such as machine learning.

Aspects of the present disclosure address the above and other deficiencies by a memory sub-system that manages the performance of input/output (I/O) operations (e.g., operations that are data-intensive or memory-intensive, as described above) associated with a compute express link (CXL) memory device implementing dynamic capacity. Dynamic capacity (DC) is a feature of a CXL memory device that allows memory capacity to change dynamically without the need for resetting the CXL memory device, such that memory capacity allocated to one or more host devices can be changed (e.g., added or released) at runtime. A dynamic capacity device (DCD) is a CXL memory device that implements dynamic capacity (DC). A device physical address (DPA) range of a DCD can be subdivided into several memory regions (e.g., 1 to 8 regions) and each of these memory regions can be subdivided into a set of blocks. Each block, which can be allocated to a host system and associated with an identifier (also referred to as a “tag”), can be referred to as a taggable DC unit. The taggable DC unit can represent a management unit that can be tagged (e.g., associated with an identifier or “tag”), assigned to various capacity sizes, and dynamically allocated to various host systems. Each identifier is globally unique, and thus the identifiers associated with the taggable DC units can form an aggregate tag space (also referred to as a “namespace”) in the CXL memory device. The aggregate tag space can include an entry for each identifier, where each entry maps an identifier to one or more associated host systems. Each identifier can also be mapped to one or more DPA ranges (e.g., a set of one or more contiguous physical address ranges or non-contiguous physical address ranges that identify respective locations storing data on the DCDs). The one or more DPA ranges mapped to an identifier can be shareable or not among the one or more host systems, such that each of the one or more host systems can access data stored at the one or more DPA ranges or be restricted from accessing the data stored at the one or more DPA ranges.

In some DCDs, the fabric manager controls the allocation of these taggable DC units to one or more host systems (or a group of host systems) and utilizes events (e.g., notifications, interrupts, etc.) to signal to the host systems when changes to the allocation of these taggable DC units occur. The fabric manager also assigns an identifier to an allocated taggable DC unit by associating, in a mapping data structure, the identifier of a taggable DC unit with one or more physical address ranges (e.g., DPA ranges). The DCD can map these DPA ranges to corresponding virtual address ranges within a virtual address space of the host system. The DCD implements a set of commands for querying and configuring taggable DC units. The set of commands can include a command allocating new taggable DC units (e.g., add dynamic capacity response command), a command releasing the taggable DC units (e.g., release dynamic capacity command), and a command getting information related to the taggable DC units. The capacity of a taggable DC unit associated with an identifier and allocated to a host system is immutable if the taggable DC unit is shareable among one or more host systems, such that no additional capacity can be added to the taggable DC unit, nor can some capacity be deleted from the taggable DC unit. Further, although the content stored in a taggable DC unit can be modified, the mapping between the identifier of the taggable DC unit and a host system cannot be modified. If a taggable DC unit is not shareable among one or more host systems, the mapping between the identifier of the taggable DC unit and a host system can be modified.

In some embodiments, a host system can send to a dynamic capacity device and/or a fabric manager a request to perform an input/output (I/O) operation. The I/O operation can be a read operation or write operation, such as a machine learning operation. The machine learning operation can be, for example, an operation that is performed using a machine learning model, where the machine learning model can be trained to make an inference or prediction based on a certain input. Machine learning tasks can include image classification, image recognition, speech recognition, etc. The request can specify a memory region of a dynamic capacity device at which to perform the I/O operation. Processing logic (e.g., the fabric manager) can look up, using a data structure that references the namespace that is accessible to the host system and the dynamic capacity device, a range of physical addresses within the memory region of the dynamic capacity device corresponding to the memory region specified by the request. The data structure can include a set of entries, such that each entry includes a mapping between an identifier of the dynamic capacity device and the corresponding range of physical addresses within the memory region of the dynamic capacity device. The processing logic can cause the I/O operation to be performed on a set of memory cells that are addressable at the identified range of physical addresses within the memory region of the dynamic capacity device.

Advantages of the present disclosure include enabling near-memory computing (NMC), also known as in-memory computing, in order to reduce the time and resources needed to perform computations by performing the computations close to where the data is stored. This can result in faster data access and reduced latency and bottleneck issues by avoiding having to move data back and forth between storage and processing units. NMC also aids in addressing the scalability limitations in some memory devices by adding more memory and processing units. NMC can be especially beneficial for computations involving machine learning, which can be highly memory intensive. There can thus be a more efficient use of memory resources and increased memory bandwidth. These and other features of the embodiments of the present disclosure are described in more detail with reference to FIG. 1.

FIG. 1 illustrates a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCle controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCle interface is a physical host interface used to transmit data between the host system 120 and the CXL memory device 110 for passing control, address, data, and other signals between the CXL memory device 110 and the host system 120. The host system 120 can further utilize an NVM Express (NVMe) interface to access components of the CXL memory device 110 when the CXL memory device 110 is coupled with the host system 120 by the physical host interface (e.g., PCle bus). FIG. 1 illustrates a CXL memory device 110 as an example. In general, the host system 120 can access multiple CXL memory device 110 via a same communication connection, multiple separate communication connections, and/or a combination of communication connections. The interface can be represented by the CXL interface.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 can include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCle serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 can be a cache-coherent interconnect for processors, memory expansion, and accelerators. The computing system 100 maintains memory coherency between the CPU memory space and memory on memory-attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCle-like protocol that can viewed as an “enhanced” PCle protocol capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCle physical layer.

The CXL memory device 110 is a memory device that allows the host system 120 to use as a memory buffer for memory bandwidth expansion, memory capacity expansion, and persistent memory applications, and as small-scale resource pooling and large-scale resource pooling and sharing.

In some implementations, the CXL memory device can partition memory resources into multiple logical devices, and each logical device can be visible as a memory device. One of the multiple logical devices can be reserved for a fabric manager to configure resource allocation across the logical devices, while the other logical devices can be available for assigning to the host. In some implementations, the CXL memory device can be a device that supports multiple host systems and can be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application-specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control the operation of the CXL memory device 110, including handling communications between the CXL memory device 110 and the host system 120. The CXL memory device controller 115 can manage operations of CXL memory device 110, such as writes to and reads from DCD 130A-130N. The CXL memory device controller 115 can include one or more processors 117, which can be multi-core processors. Processors 117 can handle or interact with the components of DCD 130A-130N, generally through firmware code. The CXL memory device controller 115 can operate under CXL protocol, but other protocols are applicable.

The CXL memory device controller 115 executes computer-readable program code (e.g., software or firmware) executable instructions (herein referred to as “instructions”). The instructions can be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 can be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 can interact with DCD 130A-130N for read and write operations. The CXL memory device controller 115 can execute the direct memory access (DMA) for data transfers between host system 120 and DCD 130A-130N without involvement from CPU 109. The CXL memory device controller 115 can control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations, including computation offloading tasks (e.g., machine learning operations) from the host system 120 and/or a fabric manager 140 and/or an orchestrator on behalf of the host system 120 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a DCD 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a fabric manager 140. The fabric manager 140 can be external to each of the DCDs 130A-130N and/or the host system 120. The fabric manager 140 can query and configure the operational state of the computing system 110. In some embodiments, the fabric manager 140 can configure a shared access between a memory region of a DCD of the DCDs 130A-130N and the host system 120. In some embodiments, the fabric manager 140 can configure an access privilege by the host system 120 to a memory region of a DCD of the DCDs 130A-130N. In some embodiments, the fabric manager 140 can be software running on the host system 120, firmware embedded within a Baseboard Management Controller (BMC) of a distributed application, or a dedicated device running in the CXL device. The fabric manager 140 can assign a (logical) device (e.g., DCDs 130A-130N) to the host system 120 by using command sets through the Component Command Interface (CCI). CCI can be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 can assign one taggable DC unit to the host system 120 and create a globally unique identifier attached to the taggable DC unit as a tagged capacity unit 137; the fabric manager 140 can assign another taggable DC unit to the host system 120 and create a globally unique identifier attached to the taggable DC unit as a tagged capacity unit 138. In some implementations, some or all of the functionality of the fabric manager 140 can be performed by the controller 115 and/or an I/O operation management component 113.

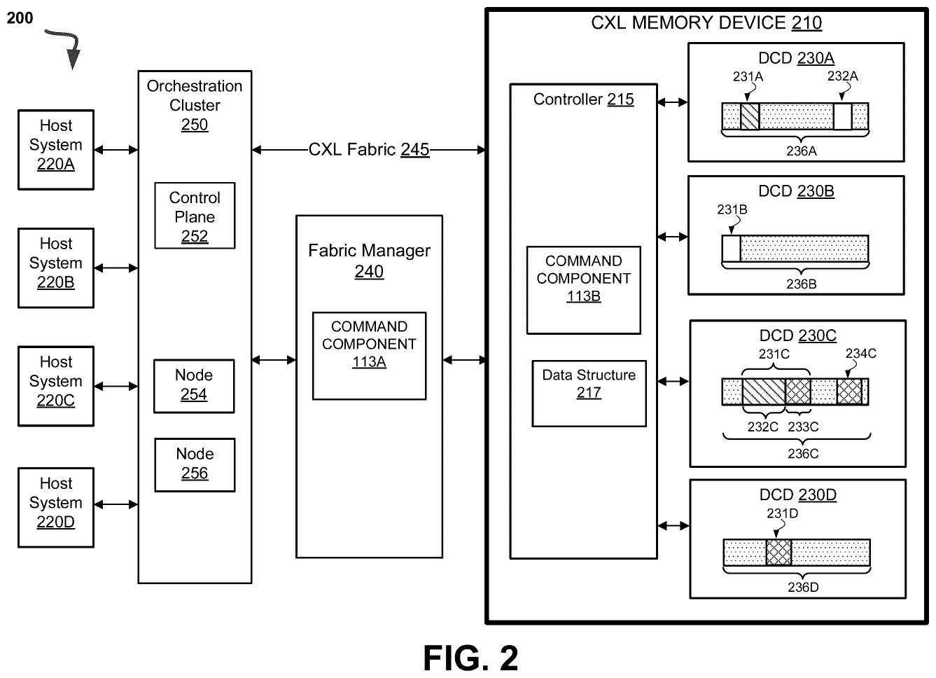

In some embodiments, the CXL memory device 110 includes the I/O operation management component 113 that enables the host system 120 to perform an operation (e.g., a write operation or read operation). In some embodiments, the CXL memory device controller 115 includes at least a portion of the I/O operation management component 113. In some embodiments, the I/O operation management component 113 is part of the host system 120, an application, or an operating system. In other embodiments, local media controller 135 includes at least a portion of the computation offloading task management component 113 and is configured to perform the functionality described herein. Further details regarding the operations of the I/O operation management component 113 are described below with reference to FIGS. 2-5. In some implementations, the I/O operation management component 113 includes a command component 113A and a command component 113B as shown in FIG. 2, which can operate together to perform the functionality of the I/O operation management component 113. In some implementations, some or all of the functionalities of the I/O operation management component 113 can be performed by the fabric manager 240, the controller 215, the command component 113A, the command component 113B, and/or the combination thereof, as shown in FIG. 2.

In some embodiments, the I/O operation management component 113 can receive, from a host system (e.g., a host system 220A-N), a request to perform an input/output (I/O) operation (e.g., a machine learning operation). The request can specify a memory region of a dynamic capacity device at which to perform the I/O operation. The I/O operation management component 113 can determine, using a data structure that references the namespace that is accessible to the host system and the dynamic capacity device, a range of physical addresses within the memory region of the dynamic capacity device corresponding to the memory region specified by the request. The data structure can include a set of entries, where each entry includes a mapping between an identifier of the dynamic capacity device and the corresponding range of physical addresses within the memory region of the dynamic capacity device. The I/O operation management component 113 can cause the I/O operation to be performed on a set of memory cells that are addressable at the determined range of physical addresses within the memory region of the dynamic capacity device. For example, the I/O operation management component 113 can send the request to perform the I/O operation to the dynamic capacity device.

It will be appreciated by those skilled in the art that additional circuitry and signals can be provided, and that the components of FIG. 1 have been simplified. It should be recognized that the functionality of the various block components described with reference to FIG. 1 may not necessarily be segregated into distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a block diagram of an example system for managing the performance of I/O operations associated with a compute express link (CXL) memory device, in accordance with some embodiments of the present disclosure. In various embodiments, the system 200 includes one or more host systems 220A-D (such as the host system 120), a CXL memory device 210 (such as the CXL memory device 110) that includes a controller 215 (e.g., controller 115), a CXL fabric 245, a fabric manager 240, and an orchestration cluster 250. In some embodiments, aspects (to include hardware and/or firmware functionality) of the controller 215 are included in the processing logic of DCDs 230A-230D.

In the example of FIG. 2, the DCD 230A can include a first region 236A, the DCD 230B can include a second region 236B, the DCD 230C can include a third region 236C, and the DCD 230D can include a fourth region 236D. As shown in FIG. 2, each region of the first region 236A, second region 236B, third region 236C, and fourth region 236D can include eight taggable dynamic capacity units, and each taggable dynamic capacity unit can be of a uniform capacity size. Although a specific number of taggable dynamic capacity units is shown in FIG. 2 and taggable dynamic capacity units shown in FIG. 2 have the same capacity size, various capacity sizes can be allocated to the taggable dynamic capacity units according to the request of the host systems, and the number of taggable dynamic capacity units included in a DCD can vary. In some implementations, the capacity size of a taggable dynamic capacity unit can be a multiple of a minimum capacity size, and the minimum capacity size can be 2 MB, 0.5 GB, 1 GB, etc.

The orchestration cluster 250 may be a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestration cluster 250 can include nodes 254, 256 to execute applications and/or processes associated with the applications. A “node” providing computing functionality can provide the execution environment for an application of the PaaS system. In some implementations, the “node” can include a virtual machine that is hosted on a physical machine, such as the host system 220A-220D implemented as part of the clouds. In some implementations, nodes 254, 256 can additionally or alternatively include a group of VMs, a container, or a group of containers to execute functionality of the PaaS applications. When nodes 254, 256 are implemented as VMs, they can be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The orchestration cluster 250 can include a control plane 252. The control plane 252 can make global control and management decisions about a cluster. The control plane 252 is responsible for maintaining the desired state (i.e., a state desired by a client when running the cluster) of the orchestration cluster 250, such as which applications are running and which container images they use, which resources should be made available for them, and other configuration details. In some implementations, the orchestration cluster 250 is managed by a container orchestration system, such as Kubernetes.

The DCDs 230A-230D can be connected to the orchestration cluster 250 via a network connection interface utilizing the high-speed bus (e.g., a Peripheral Component Interconnect Express (PCIe) bus), such as a compute express link (CXL) fabric interconnect. The compute express link (CXL) fabric interconnect can provide an interface that can support several protocols that can run on top of PCle, including a CXL.io protocol, a CXL.mem protocol, and a CXL.cache protocol.

The host systems 220A-D, through a node of the orchestration cluster 250, can request allocation of tagged capacity in DCDs 230A-230D. For example, a host system 220A-D, through nodes 254, 256 (e.g., an application, a VM) running on the orchestration cluster 250, can request allocation of tagged capacity in DCDs 230A-230D, where the request can specify a capacity size.

For initial allocation of tagged capacity, the controller 215 and/or the fabric manager 240 can determine the portions of the DCDs 230A-230D for allocation. In some implementations, the controller 215 can determine an available portion, in the requested capacity size, of the DCDs 230A-230D to be allocated to the host system 220A and request the fabric manager 240 to provide an identifier. The controller 215 can receive the identifier from the fabric manager 240 and assign the identifier to the allocated portion referred to as the tagged capacity unit, for example, the tagged capacity unit 231A, or the tagged capacity unit 231C. In some implementations, the fabric manager 240 can determine an available portion, in the requested capacity size, of the DCDs 230A-230D to be allocated to the host system 220A and assign an identifier to the allocated portion referred to as the tagged capacity unit, for example, the tagged capacity unit 231A, or the tagged capacity unit 231C. In various implementations, the identifier is created by the fabric manager 240 so that the identifier is globally unique. The controller 215 can store, in the data structure 217, the identifier, the DPA ranges of the allocated portions of the DCDs 230A-230D, and the host identifier that defines the host system that can access the identifier.

Upon the initial allocation of the tagged capacity unit, the host system 220A-220D can write data to the tagged capacity unit. For example, upon the initial allocation of the tagged capacity unit 231A to the host system 220A, the controller 215 can receive, from host system 220A, data created by an application running on node 254. The controller 215 can store the data in the tagged capacity unit 231A. In some embodiments, storing the data can include the controller 215 writing the data to the tagged capacity unit 231A. In some embodiments, storing the data can further include the controller 215 mapping one or more DPA ranges identifying respective physical locations at which the data resides on the CXL memory device 210 with corresponding virtual address ranges in the virtual address space available to the host system 220C.

In another example, upon the initial allocation of the tagged capacity unit 231C to the host system 220C, the controller 215 can receive, from host system 220C, data created by an application running on node 254. The controller 215 can store the data in the tagged capacity unit 231C. In some embodiments, storing the data can include the controller 215 writing the data to the tagged capacity unit 231C. In some embodiments, storing the data can further include the controller 215 mapping one or more DPA ranges identifying respective physical locations at which the data resides on the CXL memory device 210 with corresponding virtual address ranges in the virtual address space available to the host system 220C.

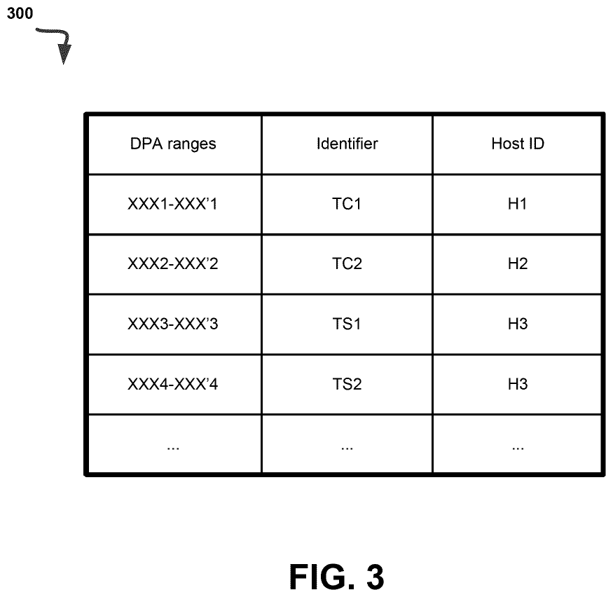

FIG. 3 illustrates an example of data structure 300 (e.g., the data structure 217 of FIG. 2) referencing a namespace accessible to a host system and to a set of dynamic capacity devices, in accordance with some embodiments of the present disclosure. The data structure 300 can include an item “DPA ranges,” an item “identifier,” and an item “host ID.” The item “DPA ranges” indicates the locations (e.g., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “identifier” indicates the identifier associated with the tagged capacity unit. The item “host ID” indicates the host system to which the tagged capacity unit associated with the identifier can be accessed.

In view of the item “DPA ranges,” an item “identifier,” and an item “host ID,” the data structure 300 can be used to map the DPA ranges to the host system by mapping the physical address ranges of the identifier to corresponding virtual address ranges in a virtual address space of the host system (i.e., the virtual/logical address space allocated by a host system to a host application that is permitted to access the data).

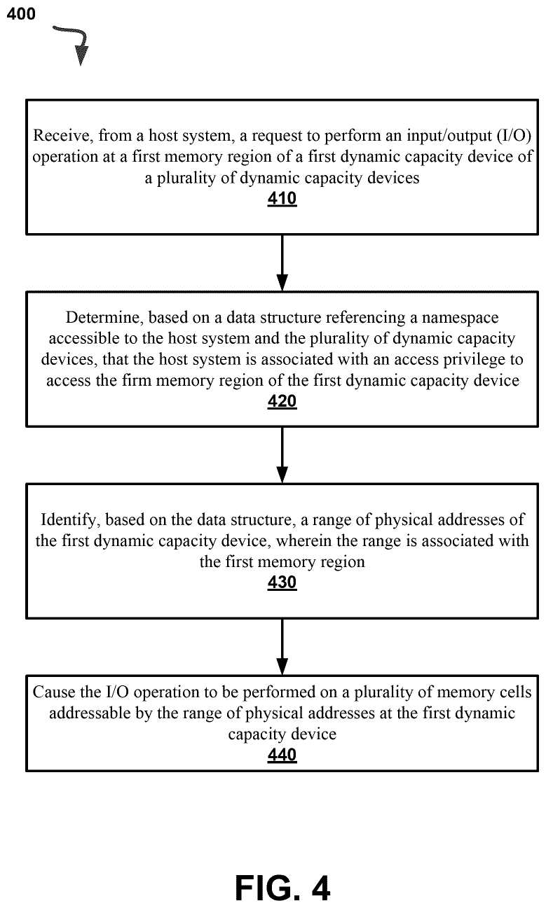

FIG. 4 is a flow diagram of an example method 400 for managing the performance of input/output (I/O) operations associated with a compute express link (CXL) memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the I/O operation management component 113 of FIG. 1 or the controller 215 (including the command component 113B) and the fabric manager 240 (including the command component 113A) of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives a request to perform an input/output (I/O) operation. In some embodiments, the I/O operation can refer to an operation that is a memory-intensive task and/or a data-intensive task, such as a machine learning operation. A machine learning operation can be, for example, an operation that is performed using a machine learning model, where the machine learning model can be trained to make an inference or prediction based on certain input. Machine learning tasks can include image classification, image recognition, speech recognition, etc. The processing logic can receive the request from a host system (e.g., a host system 220A-220D of FIG. 2). In some embodiments, the request can include an identifier of a memory region (e.g., a first memory region) (e.g., regions 236A, 236B, 236C, 236D of FIG. 2) of a dynamic capacity device (e.g., a first dynamic capacity device) of a set of dynamic capacity devices (e.g., DCD 230A, 230B, 230C, 230D of FIG. 2). In some implementations, each of the set of dynamic capacity devices includes a set of memory regions, where each memory region of the set of memory regions is associated with a respective identifier of a set of identifiers. Each of the set of identifiers can be unique. In some implementations, the identifier is shared by the host system and another host system. In some implementations, the capacity of the memory region associated with the identifier is immutable. In some embodiments, each of the set of dynamic capacity devices and the host system are connected with a set of CXL links. In some implementations, the memory region is accessible by the host system, and another (e.g., a second) memory region is accessible by another (e.g., a second) host system. In some implementations, the memory region is exclusively accessible by the host system, and the second memory section is exclusively accessible by the second host system.

At operation 420, the processing logic determines that the host system is associated with an access privilege to access the memory region (e.g., the first memory region) of the dynamic capacity device. In some embodiments, to determine that the host system is associated with the access privilege, the processing logic uses a data structure referencing a namespace that is accessible to the host system and to the set of dynamic capacity devices. In some implementations, the data structure can be the data structure 217 of FIG. 2 and/or the data structure 300 of FIG. 3. In some embodiments, the data structure can include a set of entries. Each entry can include an identifier of a memory region of a dynamic capacity device, an identifier of a corresponding range of physical addresses of the dynamic capacity device, and/or an identifier of one or more host systems of a set of host systems, where the memory region is accessible by the one or more host systems. In some implementations, a fabric management component of one or more of the set of dynamic capacity devices (e.g., the fabric manager 140 of FIG. 1 and/or the fabric manager 240 of FIG. 2) can configure shared access between the one or more host systems and the memory region (e.g., whether multiple host systems can share access to the memory region, or whether a single host system has exclusive access to the memory region). In some implementations, the fabric management component can configure an access privilege of each of the one or more host systems to the memory region (e.g., whether a host system can access the memory region). In some implementations, the fabric management component can configure the shared access and/or the access privilege using an application programming interface (API) of an orchestrator (e.g., the orchestration cluster 250 of FIG. 2).

At operation 430, the processing logic identifies a range of physical addresses of the dynamic capacity device that is associated with the memory region. In some implementations, to identify the range of physical addresses, the processing logic uses the data structure referencing the namespace (e.g., the data structure 217 of FIG. 2 and/or the data structure 300 of FIG. 3). For example, the processing logic identifies an entry of the data structure that stores an identifier of the memory region (e.g., an identifier of the first memory region). In response to identifying the entry storing the identifier of the first memory region, the processing logic can identify the corresponding range of physical addresses of the dynamic capacity device.

At operation 440, the processing logic causes the I/O operation to be performed on a set of memory cells that are addressable by the range of physical addresses at the dynamic capacity device determined at operation 430. In some implementations, causing the I/O operation to be performed includes sending the request to perform the I/O operation to the dynamic capacity device to be performed at the identified range of physical addresses. In some implementations, in response to the I/O operation being performed, the processing logic can identify another (e.g., a second) memory region corresponding to another (e.g., a second) range of physical addresses at the dynamic capacity device. The processing logic can store, in an entry of the data structure, a mapping between an identifier of the second memory region and the second range of physical addresses. The processing logic can store data corresponding to one or more results of the I/O operation at the second memory region. In some implementations, the second memory region is accessible by the host system and one or more other host systems. In some implementations, the second memory region is exclusively accessible by the host system.

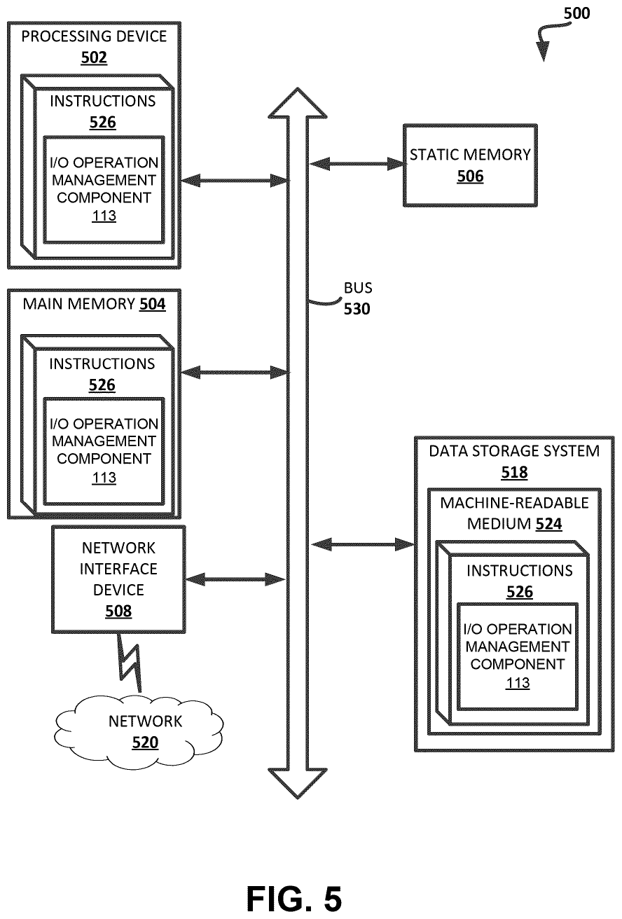

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the I/O operation management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to the I/O operation management component 113 of FIG. 1 and method 400 of FIG. 4. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of dynamic capacity devices; and
a processing device, operatively coupled with the plurality of dynamic capacity devices, to perform operations comprising:
receiving, from a host system, a request to perform an input/output (I/O) operation at a first memory region of a first dynamic capacity device of the plurality of dynamic capacity devices;
determining, based on a data structure referencing a namespace accessible to the host system and to the plurality of dynamic capacity devices, that the host system is associated with an access privilege to access the first memory region of the first dynamic capacity device;
identifying, based on the data structure, a range of physical addresses of the first dynamic capacity device, wherein the range is associated with the first memory region; and
causing the I/O operation to be performed on a plurality of memory cells addressable by the range of physical addresses at the first dynamic capacity device.

2. The system of claim 1, wherein each of the plurality of dynamic capacity devices is connected to the host system via a respective plurality of Compute Express Link (CXL) link.

3. The system of claim 1, wherein the data structure comprises a plurality of entries, wherein each entry comprises an identifier of a memory region, an identifier of a corresponding range of physical addresses of the plurality of dynamic capacity devices, and an identifier of one or more host systems of a plurality of host systems, wherein the memory region is accessible by the one or more host systems.

4. The system of claim 1, wherein the system further comprises a fabric management component, and wherein the fabric management component comprises firmware embedded within a baseboard management controller.

5. The system of claim 1, further comprising:
configuring at least one of: a shared access between one or more host systems and the memory region or an access privilege by the one or more host systems to the memory region.

6. The system of claim 1, further comprising:
creating an entry of the data structure, wherein the entry comprises a mapping between an identifier of the first memory region and the range of physical addresses of the first dynamic capacity device.

7. The system of claim 3, wherein the operations further comprise:
identifying data associated with one or more results of the I/O operation, wherein the data is stored on a second plurality of memory cells addressable by a second range of physical addresses associated with a second memory region of the first dynamic capacity device, and wherein an entry of the data structure comprises a mapping between an identifier of the second memory region and the second range of physical address of the first dynamic capacity device.

8. A non-transitory computer-readable storage medium comprising instructions that, when executed by a processing device, cause the processing device to perform operations comprising:
receiving, from a host system, a request to perform an input/output (I/O) operation at a first memory region of a first dynamic capacity device of a plurality of dynamic capacity devices;
determining, based on a data structure referencing a namespace accessible to the host system and to the plurality of dynamic capacity devices, that the host system is associated with an access privilege to access the first memory region of the first dynamic capacity device;
identifying, based on the data structure, a range of physical addresses of the first dynamic capacity device, wherein the range is associated with the first memory region; and
causing the I/O operation to be performed on a plurality of memory cells addressable by the range of physical addresses at the first dynamic capacity device.

9. The non-transitory computer-readable storage medium of claim 8, wherein each of the plurality of dynamic capacity devices is connected to the host system via a respective plurality of Compute Express Link (CXL) link.

10. The non-transitory computer-readable storage medium of claim 8, wherein the data structure comprises a plurality of entries, wherein each entry comprises an identifier of a memory region, an identifier of a corresponding range of physical addresses of the plurality of dynamic capacity devices, and an identifier of one or more host systems of a plurality of host systems, wherein the memory region is accessible by the one or more host systems.

11. The non-transitory computer-readable storage medium of claim 8, wherein the operations further comprise:
configuring at least one of: a shared access between one or more host systems and the memory region or an access privilege by the one or more host systems to the memory region.

12. The non-transitory computer-readable storage medium of claim 8, wherein the operations further comprise:
creating an entry of the data structure, wherein the entry comprises a mapping between an identifier of the first memory region and the range of physical addresses of the first dynamic capacity device.

13. The non-transitory computer-readable storage medium of claim 8, wherein a fabric management component associated with the plurality of dynamic capacity devices comprises firmware embedded within a baseboard management controller.

14. The non-transitory computer-readable storage medium of claim 10, wherein the operations further comprise:
identifying data associated with one or more results of the I/O operation, wherein the data is stored on a second plurality of memory cells addressable by a second range of physical addresses associated with a second memory region of the first dynamic capacity device, and wherein an entry of the data structure comprises a mapping between an identifier of the second memory region and the second range of physical address of the first dynamic capacity device.

15. A method, comprising:
receiving, from a host system, a request to perform an input/output (I/O) operation at a first memory region of a first dynamic capacity device of a plurality of dynamic capacity devices;
determining, based on a data structure referencing a namespace accessible to the host system and to the plurality of dynamic capacity devices, that the host system is associated with an access privilege to access the first memory region of the first dynamic capacity device;
identifying, based on the data structure, a range of physical addresses of the first dynamic capacity device, wherein the range is associated with the first memory region; and
causing the I/O operation to be performed on a plurality of memory cells addressable by the range of physical addresses at the first dynamic capacity device.

16. The method of claim 15, wherein each of the plurality of dynamic capacity devices is connected to the host system via a respective plurality of Compute Express Link (CXL) link.

17. The method of claim 15, wherein the data structure comprises a plurality of entries, wherein each entry comprises an identifier of a memory region, an identifier of a corresponding range of physical addresses of the plurality of dynamic capacity devices, and an identifier of one or more host systems of a plurality of host systems, wherein the memory region is accessible by the one or more host systems.

18. The method of claim 15, further comprising:
configuring at least one of: a shared access between one or more host systems and the memory region or an access privilege by the one or more host systems to the memory region.

19. The method of claim 15, further comprising:
creating an entry of the data structure, wherein the entry comprises a mapping between an identifier of the first memory region and the range of physical addresses of the first dynamic capacity device.

20. The method of claim 15, further comprising:
identifying data associated with one or more results of the I/O operation, wherein the data is stored on a second plurality of memory cells addressable by a second range of physical addresses associated with a second memory region of the first dynamic capacity device, and wherein an entry of the data structure comprises a mapping between an identifier of the second memory region and the second range of physical address of the first dynamic capacity device.
